(19) United States
(12) Patent Application Publication
(10) Pub. No.: US 2013/0341846 A1
(43) Pub. Date: Dec. 26, 2013

(54) ASSEMBLY FIXTURE FOR OVERSIZE LCD

(71) Applicant: Guofu Tang, Shenzhen (CN)

(72) Inventor: Guofu Tang, Shenzhen (CN)

(21) Appl. No.: 13/635,727

(22) PCT Filed: Jul. 3, 2012
(86) PCT No.: PCT/CN12/78089

§ 371 Date: Sep. 18, 2012

(30) Foreign Application Priority Data
Jun. 25, 2012 (CN) 201210208489.2

(51) Int. Cl. B25B 11/00; F16M 11/00

(52) U.S. Cl. 269/17; 248/346.03; 269/289 R

(57) ABSTRACT

The present disclosure provides an assembly fixture for an oversize liquid crystal display (LCD). The assembly fixture for an oversize LCD includes a base, a fixing bracket which is connected to the base by hinges, and support rods used for keeping the fixing bracket in a fixed angle. A fixing position of the oversize LCD will not be too high by adjusting the angle of the fixing bracket. Therefore, the oversize LCD is easily installed in a high position, and the oversize LCD is installed without the cooperation of many persons and other auxiliary tools. Thus, the oversize LCD has the advantages of more convenient assembly and higher efficiency. In addition, because the fixing bracket is connected with the base by hinges, the oversize LCD is easily turned, few persons are needed, and the assembling efficiency is increased. Because the fixing bracket is smoothly turned, the fragile components of the oversize LCD fixed on the fixing bracket, the LCD panel, etc. will not slide and then bump, thereby increasing the assembling safety.

### TECHNICAL FIELD

The present disclosure relates to the manufacturing field of liquid crystal display (LCD) devices, and more particularly to an assembly fixture for an oversize LCD.

### BACKGROUND

Because oversize liquid crystal display (LCDs) have large length size and width size, and some oversize LCDs are even higher than the height of a person, the oversize LCDs are assembled by many persons via cooperation. Moreover, the oversize LCDs and other components of the LCDs should be assembled on corresponding oversize worktable, thereby occupying much ground space. By taking an oversize LCD of 110 inches as an example, when assembling a light source line of a backlight module, the backlight module is usually turned and erected, after that, the line is inserted into a connector. However, because the oversize LCD is heavy, much human resources and material resources are needed for turning. Thus, the working efficiency is reduced. In addition, in the process of turning, the overall strength of the LCD may be affected, and large bumping risks may exist.

Because the oversize LCD has the disadvantages of high cost of manufacture, consumption of much human resources and material resources, and occurrence of accidents such as component bump during assembly, production cost of the oversize LCD is directly affected.

### SUMMARY

In view of the above-described problems, the aim of the present disclosure is to provide an assembly fixture for an oversize liquid crystal display (LCD) with the advantages of convenient, highly efficient, and safe assembly.

The aim of the present disclosure is achieved by the following technical scheme.

An assembly fixture for an oversize LCD comprises a base, a fixing bracket which is connected to the base by a hinge and is used for fixing an LCD to be assembled, and a support rod keeping the fixing bracket in a fixed angle. The fixing bracket comprises two turning arms arranged in parallel; one end of each of the two turning arms of the fixing bracket is connected to the base by the hinge. The hinge joint of the fixing bracket and the base is configured with a limit structure limiting a rotation angle of the turning arm of the fixing bracket. The limit structure comprises a vertical face; the fixing bracket is limited by the vertical face when being turned and erected.

The aim of the present disclosure is further achieved by the following technical scheme.

An assembly fixture for an oversize LCD comprises a base, a fixing bracket which is connected to the base by a hinge and is used for fixing an LCD to be assembled, and a support rod keeping the fixing bracket in a fixed angle.

In one example, the base and the fixing bracket are respectively configured with a set structure fixing the support rod. The support rod is fixed by the set structure, thereby preventing the support rod from slipping off in a process of support.

In one example, the fixing bracket comprises two turning arms arranged in parallel. One end of each of the two turning arms of the fixing bracket is connected to the base by the hinge. The whole fixing bracket is turned by the turning arm.

In one example, a hinge joint of the fixing bracket and the base is configured with a limit structure limiting a rotation angle of the turning arm of the fixing bracket. The rotation angle of the turning arm is limited by the limit structure, which enables the fixing bracket to be rotated within a certain range, thereby facilitating the assembling of the LCD.

In one example, the limit structure comprises a vertical face; the fixing bracket is limited by the vertical face when being turned and erected. The backplane should be turned and erected in the process of assembling the LCD, so as to arrange a light source line. The turning angle of the fixing bracket is limited by the vertical face. Thus, the fixing bracket is fixedly and erectly arranged, and the backplane arranged on the fixing bracket is also erected.

In one example, a connecting bracket is arranged between the two turning arms, and both ends of the connecting bracket are respectively fixed to the turning arm. The two turning arms are connected by the connecting bracket, thereby coordinating the action of the two turning arms, and ensuring the structural stiffness of the fixing bracket.

In one example, a fixing structure fixing the backplane of the LCD is arranged in the turning arm or the connecting bracket. The fixing structure is arranged for fixing the backplane, to prevent the backplane from sliding on or slipping out of the fixing bracket.

In one example, the fixing structure is a fixing hole arranged in the turning arm, and the fixing hole corresponds to a positioning hole at an edge of the backplane arranged on the fixing bracket. The backplane is fixed to the fixing bracket by penetrating a screw or a pin into the positioning hole of the backplane and the fixing hole in the turning arm.

In one example, a bottom of the base is configured with a wheel, thereby facilitating handling the LCD during assembly.

In one example, the wheel is a universal wheel, and the universal wheel facilitates turning.

In the present disclosure, because the assembly fixture for the oversize LCD is disclosed. The assembly fixture for the oversize LCD is configured with the base, the base is configured with the fixing bracket, and the fixing bracket is connected to the base by the hinge and is kept in the fixed angle relative to the base by the support rod. When assembling the oversize LCD, the fixing position of the oversize LCD will not be too high by adjusting the angle of the fixing bracket; therefore, the subassemblies of the oversize LCD in the high position is easily installed without the cooperation of many persons and other auxiliary tools. Thus, the oversize LCD has the advantages of convenient and high efficient assembly, thereby reducing the cost. In addition, because the oversize LCD is fixed by the fixing bracket, and the fixing bracket is connected with the base by the hinge, the oversize LCD is easily turned, few persons are needed, and the assembling efficiency is increased. Because the fixing bracket is connected by the hinge and is smoothly turned, the fragile components of the oversize LCD fixed on the fixing bracket, the LCD panel, etc. will not slide and then bump, thereby increasing the assembling safety. Under the condition of guaranteeing safety, the production cost of the oversize LCD is reduced.

### BRIEF DESCRIPTION OF FIGURES

FIG. 1 is a simplified schematic diagram of an assembly fixture and a backplane arranged thereon of an example of the present disclosure;

FIG. 2 is a simplified schematic diagram of an assembly fixture of an example of the present disclosure;

FIG. 3 is a simplified schematic diagram of an assembly fixture and a backplane arranged thereon which is being turned and erected of an example of the present disclosure;

FIG. 4 is a simplified schematic diagram of an assembly fixture of an example of the present disclosure;

FIG. 5 is a simplified schematic diagram of a base and a turning arm of an assembly fixture of an example of the present disclosure; and

FIG. 6 is a simplified schematic diagram of a base and a turning arm of an assembly fixture of an example of the present disclosure.

Legends: 100. assembly fixture; 110. base; 120. turning arm; 121. support rod; 122. connecting bracket; 123. fixing hole; 130. axle seat; 131. limit structure; 140. universal wheel; 300. backplane; 310. turning structure; 311. positioning hole.

### DETAILED DESCRIPTION

The present disclosure will further be described in detail in accordance with the figures and the preferable examples.

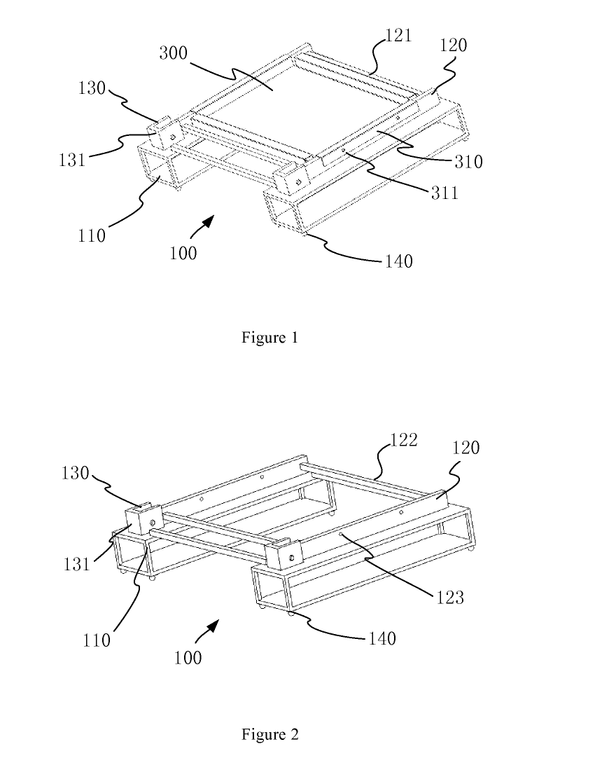

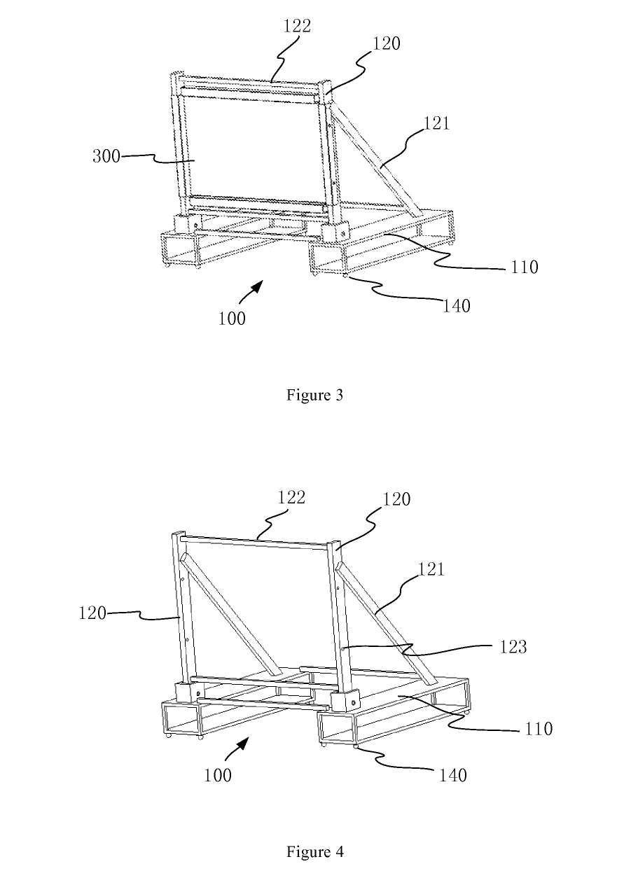

FIGS. 1-4 show a specific example of the present disclosure. The example is specifically explained by an assembly fixture for an oversize LCD of 110 inches. The assembly fixture comprises a base 110, a fixing bracket which is connected to the base 110 by a hinge and is used for fixing an LCD to be assembled, and a support rod 121 keeping the fixing bracket in a fixed angle. The LCD to be assembled is arranged on the fixing bracket, as shown in FIG. 1 and FIG. 3, the backplane 300 is fixed to the fixing bracket before assembling the LCD of 110 inches, and the assembling operation of other components of the LCD is performed from the backplane 300 on the assembly fixture 100.

The support rod 121 is used for keeping the angle of the fixing bracket 120. In the assembling operation of the LCD of 110 inches, when assembling a light source line of a backlight module, the backlight module is turned and erected, after that, the line is inserted into a connector. After being turned and erected, the fixing bracket 120 is supported by the support rod 121 and is kept in an erect state, to facilitate assembling the LCD. The base 110 and the fixing bracket 120 are respectively configured with a set structure fixing the support rod 121, and the support rod 121 is added after turning and erecting the fixing bracket 120. Thus, the fixing structure can be a limit block arranged on the base 110 and the fixing bracket 120 (not shown in the Figures). Optionally, the support rod 121 can also be connected to the base 110 by the hinge.

Because the LCD of 110 inches is higher than a human body, the angle of the fixing bracket 120 is adjusted by the support rod 121, to enable workers to assemble the subassemblies of the LCD which is in the high position.

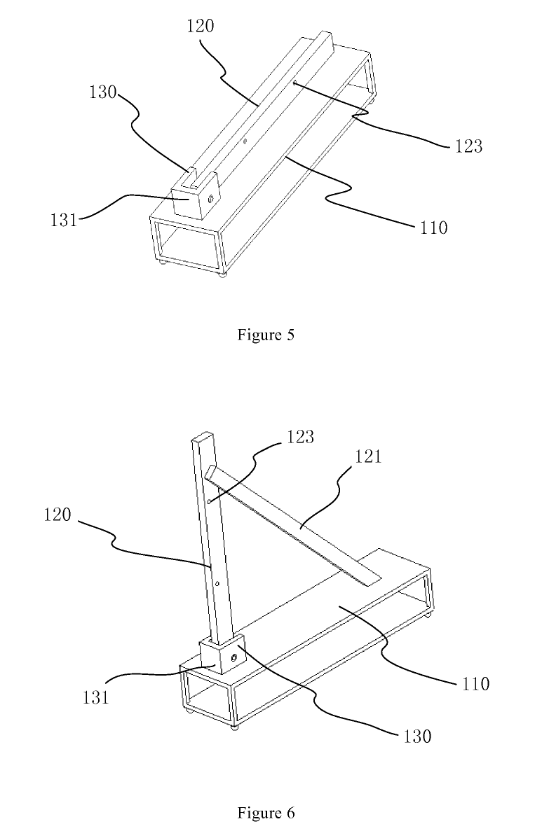

As shown in FIGS. 1-4, the fixing bracket comprises two turning arms 120 arranged in parallel, one end of each of the two turning arms 120 of the fixing bracket is connected to the base 110 by the hinge, and the fixing bracket is turned by the turning arm 120. As shown in FIG. 5, one end of the turning arm 120 is arranged on an axle seat 130 by a pin shaft, the axle seat 130 is further configured with a limit structure 131, and an inner side of the limit structure 131 is configured with a vertical face. As shown in FIG. 6, when being turned and erected, the turning arm 120 is limited by the vertical face of the inner side of the limit structure 131 and is not allowed to be turned any longer, and the fixing bracket is kept in the erect state by matching with the support function of the support rod 121. As shown in FIG. 2, the two turning arms 120 are connected by a connecting bracket 122, and both ends of the connecting bracket 122 are respectively fixed to the turning arm 120, to ensure the simultaneous turning of the two turning arms 120 and enhance the structural stiffness of the fixing bracket. The structural stiffness of the LCD fixed to the fixing bracket is increased by enhancing the structural stiffness of the fixing bracket, and damage to the components of the LCD or the LCD panel caused by deformation because of insufficient stiffness of the fixing bracket during turning is avoided.

As shown in FIGS. 1-3, an edge of the backplane 300 of the LCD to be assembled is configured with a turning structure 310, the turning structure 310 is configured with a positioning hole 311, and the backplane 300 is supported on the turning arm 120 of the fixing bracket and the connecting bracket 122 by the turning structure 310. The turning arm 120 is configured with a fixing hole 123 corresponding to the positioning hole 311, the backplane 300 is fixed by penetrating screws, pins, etc. through the positioning hole 311 and the fixing hole 123 after the backplane 300 is supported on the fixing bracket. Optionally, the fixing hole can be arranged in the connecting bracket 122.

Many persons are required for the transit of the oversize LCD, thereby affecting the working efficiency of factory workers. Moreover, the LCD may be knocked and damaged in the process of handling, and the connection strength of all the components of the backplane will be reduced if the LCD is transported for too many times. As shown in FIGS. 1-6, in the example, a bottom of the base 110 is configured with a universal wheel 140 which facilitate moving and turning in the transit process. When transporting the oversize LCD to be assembled, only the assembly fixture 100 is directly pushed forward. Thus, when transporting the LCD to be assembled, only few human resources are needed, and damage to the oversize LCD to be assembled caused by disassembly in the transit process is avoided.

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

We claim:

1. An assembly fixture for an oversize liquid crystal display (LCD), comprising:
a base,
a fixing bracket which is connected to the base by a hinge and is used for fixing an LCD to be assembled, and
a support rod used for keeping the fixing bracket in a fixed angle;
wherein the fixing bracket comprises two turning arms arranged in parallel, and one end of each of the two turning arms of the fixing bracket is connected to the base by the hinge;
wherein a hinge joint of the fixing bracket and the base is configured with a limit structure limiting a rotation angle of the turning arm of the fixing bracket; the limit structure comprises a vertical face, and the fixing bracket is limited by the vertical face when being turned and erected.

2. An assembly fixture for an oversize liquid crystal display (LCD), comprising;
a base,
a fixing bracket which is connected to the base by a hinge and is used for fixing an LCD to be assembled, and
a support rod used for keeping the fixing bracket in a fixed angle.

3. The assembly fixture for the oversize LCD of claim 2, wherein the base and the fixing bracket are respectively configured with a set structure fixing the support rod.

4. The assembly fixture for the oversize LCD of claim 2, wherein the fixing bracket comprises two turning arms arranged in parallel, and one end of each of the two turning arms of the fixing bracket is connected to the base by the hinge.

5. The assembly fixture for the oversize LCD of claim 4, wherein a hinge joint of the fixing bracket and the base is configured with a limit structure limiting a rotation angle of the turning arm of the fixing bracket.

6. The assembly fixture for the oversize LCD of claim 5, wherein the limit structure comprises a vertical face; the fixing bracket is limited by the vertical face when being turned and erected.

7. The assembly fixture for the oversize LCD of claim 4, wherein a connecting bracket is arranged between the two turning arms, and both ends of the connecting bracket are respectively fixed to the turning arm.

8. The assembly fixture for the oversize LCD of claim 2, wherein the turning arm or the connecting bracket is configured with a fixing structure fixing a backplane of the LCD.

9. The assembly fixture for the oversize LCD of claim 8, wherein the fixing structure is a fixing hole arranged in the turning arm, and the fixing hole corresponds to a positioning hole at an edge of the backplane arranged on the fixing bracket.

10. The assembly fixture for the oversize LCD of claim 2, wherein a bottom of the base is configured with a wheel.

11. The assembly fixture for the oversize LCD of claim 10, wherein the wheel is a universal wheel.
